(19) United States
(12) Patent Application Publication
(10) Pub. No.: US 2025/0150702 A1
(43) Pub. Date: May 8, 2025

(54) CAMERA MODULE

(71) Applicant: Samsung Electro-Mechanics Co., Ltd., Suwon-si (KR)

(72) Inventors: Seung-Hyeon JEONG, Suwon-si (KR); Sangjoon KIM, Suwon-si (KR); Taewon KANG, Suwon-si (KR); Youngrok PARK, Suwon-si (KR); Jihae LEE, Suwon-si (KR)

(73) Assignee: Samsung Electro-Mechanics Co., Ltd., Suwon-si (KR)

(21) Appl. No.: 18/886,227

(22) Filed: Sep. 16, 2024

(30) Foreign Application Priority Data
Nov. 7, 2023 (KR) 10-2023-0152569
Apr. 8, 2024 (KR) 10-2024-0047318

(51) Int. Cl. H04N 23/57; G03B 5/00; G03B 30/00; H04N 23/51; H04N 23/54

(52) U.S. Cl. CPC H04N 23/57; G03B 30/00; H04N 23/51; H04N 23/54; G03B 5/00; G03B 2205/0007

(57) ABSTRACT

A camera module includes a housing that accommodates a lens barrel, and a cover that covers the housing. The cover includes a connection portion connected to a first circuit board by a first solder to provide a ground to the first circuit board. The connection portion has a first concave portion having a concave shape in a first direction from the first circuit board toward the housing.

### CROSS-REFERENCE TO RELATED APPLICATIONS

This application claims the benefit under 35 USC 119 (a) of Korean Patent Application No. 10-2024-0047318 filed in the Korean Intellectual Property Office on Apr. 8, 2024, and Korean Patent Application No. 10-2023-0152569 filed in the Korean Intellectual Property Office on Nov. 7, 2023, the entire disclosures of which are incorporated herein by reference for all purposes.

### BACKGROUND

### 1. Field

The present disclosure relates to a camera module.

### 2. Description of the Background

With the remarkable development of information communication technologies and semiconductor technologies, the use of electronic devices has rapidly spread. As such, cameras may be applied to portable electronic devices such as smartphones, tablet PCs, and laptop computers.

In particular, many electronic components may be mounted in an electronic device such as a smartphone. Therefore, it may be necessary to minimize a degree to which electromagnetic waves, which may be generated from the electronic components in the electronic device, are discharged to the outside. In addition, it may be necessary to prevent the electronic component in the electronic device from being damaged by a noise electric current or the like introduced from the outside. Therefore, the camera module, which is mounted in the electronic device, may be manufactured so that a cover and a circuit board are basically grounded to prevent electromagnetic waves from leaking to the outside and prevent the electronic component from being damaged by the external electric current.

A conductive tape may be used to ground the camera module. However, the grounding method may be a soldering method to prevent a thickness of the conductive tape from affecting a thickness of the camera module. The grounding method using soldering may cause cracks due to a difference in thermal expansion rate, which may result in a risk that the ground fails.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing that accommodates a lens barrel, and a cover covering the housing. The cover includes a connection portion connected to a first circuit board by a first solder to provide a ground to the first circuit board. The connection portion has a first concave portion having a concave shape in a first direction from the first circuit board toward the housing.

The connection portion may be connected to a ground pad of the first circuit board by the first solder to provide the ground to the first circuit board.

The first concave portion of the connection portion may be entirely covered by the first solder.

The connection portion may further have a first convex portion and a second convex portion each having a convex shape in a direction from the housing toward the first circuit board, and the first concave portion may be disposed between the first convex portion and the second convex portion.

The connection portion may further have a second concave portion and a third concave portion each having a concave shape in the first direction, the first convex portion may be disposed between the first concave portion and the second concave portion, and the second convex portion may be disposed between the first concave portion and the third concave portion.

An image sensor may be mounted on the first circuit board.

The connection portion may be connected to a dummy pad of a second circuit board by the first solder, and an optical image stabilization (OIS) driving coil may be mounted on the second circuit board.

A signal pad of the first circuit board and a signal pad of the second circuit board may be connected by a second solder.

The second solder may be spaced apart from the cover.

In another general aspect, a camera module includes a lens barrel that accommodates a lens, a housing that accommodates the lens barrel, a first circuit board on which the housing is seated, and a cover that covers the housing. The cover includes a connection portion connected to a ground pad of the first circuit board by first solder. The connection portion has a first concave portion having a concave shape in a first direction from the first circuit board toward the housing, and a convex portion having a convex shape in a direction from the housing toward the first circuit board.

The first concave portion of the connection portion may be entirely covered by the first solder.

The connection portion may further have a second concave portion having a concave shape in the first direction, and the convex portion may be disposed between the first concave portion and the second concave portion.

The camera module may further include a second circuit board connected to the housing in a second direction intersecting the first direction. The connection portion may be connected to a dummy pad of the second circuit board by the first solder.

The first concave portion may overlap the dummy pad of the second circuit board.

Other features and aspects will be apparent from the following detailed description, the drawings, and the claims.

### BRIEF DESCRIPTION OF THE DRAWINGS

FIG. 1 is a perspective view illustrating an external appearance of a camera module according to one or more embodiments.

FIG. 2 is an exploded perspective view schematically illustrating the camera module illustrated in FIG. 1.

FIG. 3 is a perspective view illustrating an AF unit and a housing illustrated in FIG. 2.

FIG. 4 is a perspective view illustrating some of the components illustrated in FIG. 2.

FIG. 5 is a perspective view illustrating FIG. 4 when viewed from another side.

FIG. 6 is a perspective view illustrating a cover illustrated in FIG. 2.

FIGS. 7 to 9 are views illustrating example shapes of a connection portion of the cover.

FIG. 10 is a perspective view illustrating the cover, the housing, and an image module.

FIG. 11 is a side view illustrating the cover, a first circuit board, and a second circuit board of the present embodiment.

FIG. 12 is a side view illustrating a cover, a first circuit board, and a second circuit board of a comparative example.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION OF THE EMBODIMENTS

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

In addition, throughout the specification, the phrase “in a plan view” means when an object is viewed from above, and the phrase “in a cross-sectional view” means when a cross section made by vertically cutting an object is viewed from a lateral side.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Further, the constituent elements are defined as different names according to positions or functions thereof, but the constituent elements may be integrated.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Hereinafter, an optical axis may be set as a central axis of a lens perpendicular to a lens surface, and an optical axis direction means a direction parallel to the central axis. In the drawings, the optical axis is set as a Z-axis, and an X-axis and a Y-axis are set as directions perpendicular to the optical axis. In this case, the X-axis and the Y-axis are perpendicular to each other, and an X-Y plane defined by the X-axis and the Y-axis is a plane perpendicular to the optical axis.

According to one or more embodiments as described herein, the present disclosure provides a camera module capable of reducing the occurrence of or preventing a failure of ground.

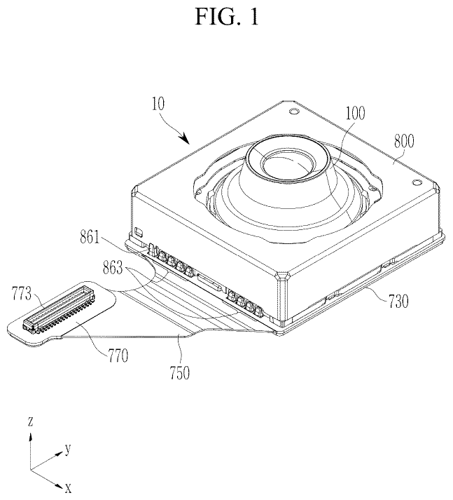

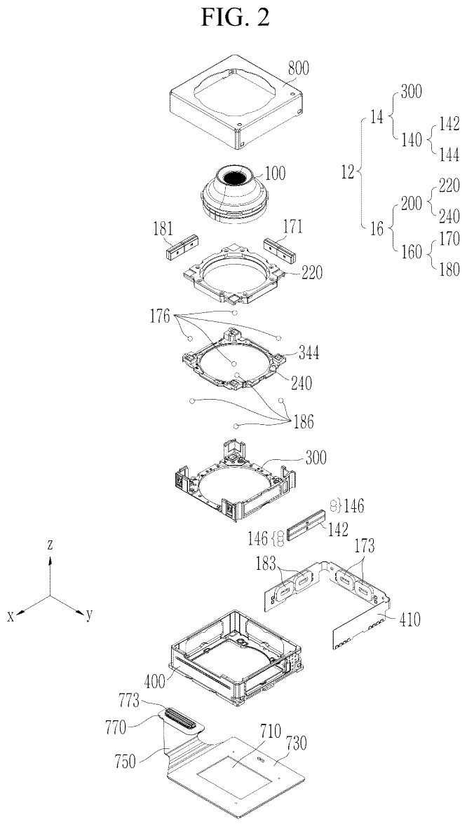

FIG. 1 is a perspective view illustrating an external appearance of a camera module 10 according to one or more embodiments, and FIG. 2 is an exploded perspective view schematically illustrating the camera module 10 illustrated in FIG. 1.

With reference to FIGS. 1 and 2, the camera module 10 according to the present embodiment includes a lens barrel 100, a lens driving device 12 configured to move the lens barrel 100, and an image module configured to convert light, which enters through the lens barrel 100, into an electrical signal. The lens barrel 100 and the lens driving device 12 are accommodated in a housing 400. The housing 400 may be covered by a cover 800.

One lens or a plurality of lenses may be mounted in the lens barrel 100 to capture images of a subject. The lens barrel 100 may have a hollow cylindrical shape, and the plurality of lenses may be accommodated in the lens barrel 100 having this shape. A necessary number of lenses may be disposed in the lens barrel 100 in accordance with design of the lens barrel 100. In case that the plurality of lenses is disposed, each of the lenses may have unique optical characteristics. For example, the plurality of lenses may each have different refractive indexes. In addition, the plurality of lenses may include lenses having the same refractive index.

The optical axis is set to describe the present embodiment. The optical axis may be set as the central axis of the lens accommodated in the lens barrel 100. The optical axis direction (Z-axis direction) means a direction parallel to the central axis of the lens. In the drawings, the optical axis is set as the Z-axis. In addition, the X-axis and the Y-axis are set as directions perpendicular to the optical axis. The X-axis and the Y-axis are set to be perpendicular to each other. The Z-axis may be set as a direction opposite to a direction in which light propagates to the lens in the camera module 10. For example, the optical axis direction (Z-axis direction) may be a direction from a first circuit board 730 toward the housing 400. For convenience of description, in the drawings, a direction in which the arrow along the Z-axis is directed is set to an upward direction, and a direction opposite to this direction is set to a downward direction. That is, the light entering the camera module 10 moves from above to below in the optical axis direction (Z-axis direction). In addition, a planar direction is defined as a direction perpendicular to the optical axis direction (Z-axis direction).

A lens holder 220 may be accommodated in the lens barrel 100, and the lens holder 220 may be accommodated in a carrier 300. The lens holder 220 has a center opening through which the lens barrel 100 may be inserted. The lens barrel 100 is coupled and fixed to the lens holder 220 through the center opening. The lens holder 220, together with the carrier 300, may be accommodated in the housing 400. For example, the lens holder 220 may have a frame shape having four edges. The housing 400 may have a frame shape having a center opening and four edges. The center opening of the lens holder 220 and the center opening of the housing 400 may be aligned in the optical axis direction (Z-axis direction).

For example, the lens holder 220 may move relative to the carrier 300 in a first direction (X-axis direction) and/or a second direction (Y-axis direction). In addition, the carrier 300 may move relative to the housing 400 in the optical axis direction (Z-axis direction). The lens holder 220 and the carrier 300 may be relatively moved by the lens driving device 12.

The lens driving device 12 is a device moving the lens barrel 100. The lens driving device 12 includes an autofocus (AF) unit 14 and an optical image stabilization (OIS) unit 16. The AF unit 14 may move the lens barrel 100 in the optical axis direction (Z-axis direction). The OIS unit 16 may move the lens barrel 100 in the direction (the X-axis direction or the Y-axis direction) perpendicular to the optical axis. For example, the lens driving device 12 may adjust a focal point or implement a zoom function by moving the lens barrel 100 in the optical axis direction (Z-axis direction) by using the AF unit 14. In addition, the lens driving device 12 may correct swaying at capturing an image by moving the lens barrel 100 in the direction (the X-axis direction or the Y-axis direction) perpendicular to the optical axis by using the OIS unit 16.

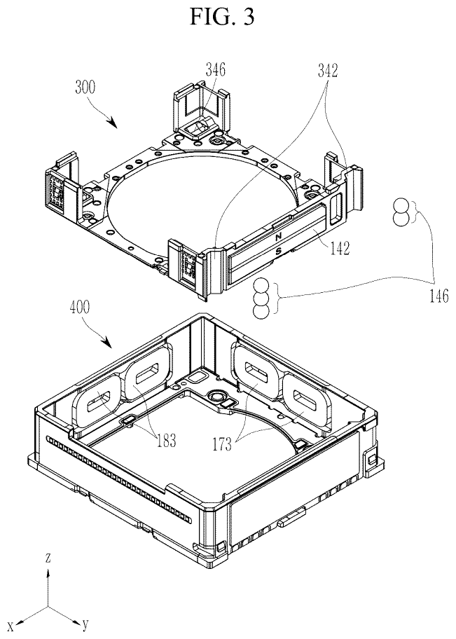

FIG. 3 is a perspective view illustrating the AF unit 14 and the housing 400 illustrated in FIG. 2.

With reference to FIGS. 2 and 3, the AF unit 14 may include the carrier 300 and an AF driving part 140. The lens barrel 100 may be accommodated in the carrier 300. The AF driving part 140 may provide driving power for moving the carrier 300, in which the lens barrel 100 is accommodated, in the optical axis direction (Z-axis direction). The AF driving part 140 may include an AF driving magnet 142 and an AF driving coil 144.

When power is applied to the AF driving coil 144, an electromagnetic force may be generated between the AF driving magnet 142 and the AF driving coil 144. Accordingly, the carrier 300 may move in the optical axis direction (Z-axis direction). Since the lens barrel 100 is accommodated in the carrier 300, the lens barrel 100 may also be moved in the optical axis direction (Z-axis direction) by the movement of the carrier 300. Accordingly, a focal point may be adjusted.

First rolling members 146 may be disposed between the carrier 300 and the housing 400. The first rolling members 146 may reduce friction between the carrier 300 and the housing 400 when the carrier 300 moves in the optical axis direction (Z-axis direction). The first rolling member 146 may have a ball shape.

First guide grooves 342 may be disposed in the carrier 300 and accommodate the first rolling members 146. The plurality of first rolling members 146 may be disposed in the first guide grooves 342 and disposed side by side in the optical axis direction (Z-axis direction). The plurality of first rolling members 146 may have different sizes. For example, among the plurality of first rolling members 146 disposed in the first guide grooves 342, the first rolling members 146, which are positioned at the uppermost and lowermost sides, may have a larger size than the first rolling member 146 positioned between the first rolling members 146 positioned at the uppermost and lowermost sides.

For example, in case that the two first guide grooves 342 are disposed, two first rolling members 146 may be disposed in one first guide groove 342, and three first rolling members 146 may be disposed in the other first guide groove 342.

The carrier 300 may have a frame shape. The first guide grooves 342 may be disposed in edge portions of the carrier 300 having a frame shape. The plurality of first guide grooves 342 may be disposed. For example, two first guide grooves 342 may be disposed at two opposite edges of one side surface of the carrier 300.

The OIS unit 16 may prevent an image from being blurred or a video from swaying because of factors such as user's hand shaking during a process of capturing an image or shooting a video. That is, when swaying occurs at capturing an image, the OIS unit 16 may compensate for the swaying by applying a relative displacement, which corresponds to the swaying, to the lens barrel 100. For example, the OIS unit 16 may correct the swaying by moving the lens barrel 100 in the first direction (X-axis direction) and the second direction (Y-axis direction) perpendicular to the optical axis direction (Z-axis direction).

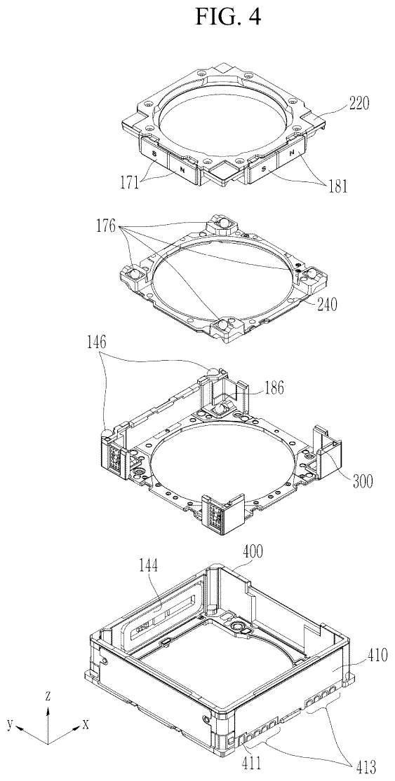

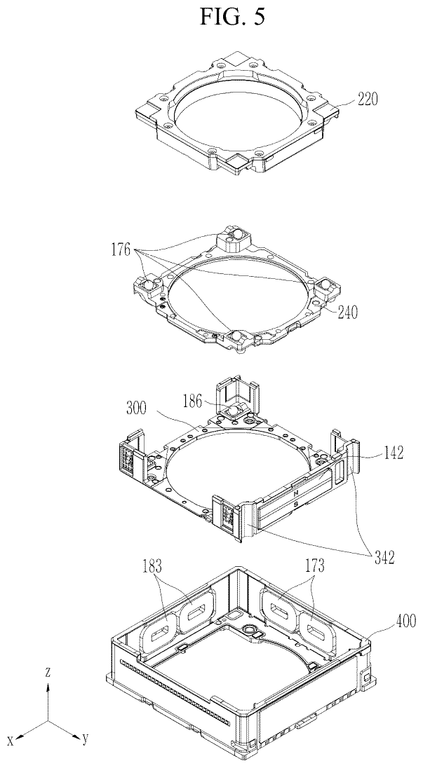

FIG. 4 is a perspective view illustrating the lens driving device and the housing illustrated in FIG. 2, and FIG. 5 is a perspective view illustrating FIG. 4 when viewed from another side.

With reference to FIGS. 2, 4, and 5, the OIS unit 16 includes a guide member 200 guiding the movement of the lens barrel 100, and an OIS driving part 160 providing driving power to the guide member 200. The guide member 200 may be moved in the direction perpendicular to the optical axis direction (Z-axis direction) by driving power provided by the OIS driving part 160.

The guide member 200 includes the lens holder 220 and a support frame 240. The lens holder 220 and the support frame 240 may be aligned in the optical axis direction (Z-axis direction) and accommodated in the carrier 300. The lens holder 220 and the support frame 240 may serve to guide the movement of the lens barrel 100 while operating in conjunction with each other. The lens holder 220 and the support frame 240 each have a center opening into which the lens barrel 100 is inserted. The lens barrel 100 may be fixed by being coupled to the lens holder 220 through the center opening. For example, the lens holder 220 may have a frame shape with four edges, and the support frame 240 may also have a frame shape with four edges and corresponding to the shape of the lens holder 220.

The OIS driving part 160 includes a first OIS driving part 170 and a second OIS driving part 180. The first OIS driving part 170 generates driving power in the first direction (X-axis direction) perpendicular to the optical axis direction (Z-axis direction), and the second OIS driving part 180 generates driving power in the second direction (Y-axis direction) perpendicular to both the optical axis direction (Z-axis direction) and the first direction (X-axis direction). The first driving part includes a first OIS driving magnet 171 and a first OIS driving coil 173, and the second driving part includes a second OIS driving magnet 181 and a second OIS driving coil 183.

The first OIS driving magnet 171 and the second OIS driving magnet 181 may be mounted on the lens holder 220. The first OIS driving coil 173 and the second OIS driving coil 183 may be disposed in the housing 400. The first OIS driving coil 173 and the second OIS driving coil 183 may be mounted on a second circuit board 410 and disposed in the housing 400 by means of the second circuit board 410. The first OIS driving magnet 171 and the first OIS driving coil 173 are disposed to face each other, and the second OIS driving magnet 181 and the second OIS driving coil 183 are disposed to face each other.

The second circuit board 410 may be coupled to the housing 400. The second circuit board 410 may be a circuit board, such as a flexible printed circuit board and a rigid flexible printed circuit board, having wiring patterns. For example, the second circuit board 410 may have a doubly curved shape. For example, in case that the housing 400 has a frame shape having four edges, the second circuit board 410 may cover three side surfaces of the housing 400 among the four side surfaces of the housing 400.

Second rolling members 176 may be disposed between the lens holder 220 and the support frame 240. The second rolling member 176 may serve to maintain an interval between the lens holder 220 and the support frame 240. In addition, the second rolling members 176 may guide the motion of the lens holder 220. Second guide grooves 344 may be formed in a surface of the support frame 240 that faces the lens holder 220 in the optical axis direction (Z-axis direction). The second guide grooves 344 may be formed only in the support frame 240 or formed in both the support frame 240 and the lens holder 220. The second rolling member 176 may be accommodated in the second guide groove 344 and disposed between the lens holder 220 and the support frame 240. In the state in which the lens holder 220 is supported by the second rolling members 176 accommodated in the second guide grooves 344, the movement of the lens holder 220 in the optical axis direction (Z-axis direction) and the second direction (Y-axis direction) may be restricted, and the lens holder 220 may move only in the first direction (X-axis direction) relative to the support frame 240. With the above-mentioned motion of the lens holder 220, the movement of the lens barrel 100 in the optical axis direction (Z-axis direction) and the second direction (Y-axis direction) may be restricted, and the lens barrel 100 may move only in the first direction (X-axis direction) relative to the support frame 240.

Third rolling members 186 may be disposed between the support frame 240 and the carrier 300. The third rolling members 186 may serve to maintain an interval between the support frame 240 and the carrier 300. In addition, the third rolling members 186 may guide the motion of the support frame 240. Third guide grooves 346 may be formed in a surface where the carrier 300 and the support frame 240 face each other in the optical axis direction (Z-axis direction). The third guide groove may be formed only in any one of the support frame 240 and the carrier 300 or formed in both the support frame 240 and the carrier 300. The third rolling member 186 may be accommodated in the third guide groove 346 and fitted between the support frame 240 and the carrier 300. In the state in which the support frame 240 is supported by the third rolling members 186 accommodated in the third guide groove 346, the movement of the support frame 240 in the optical axis direction (Z-axis direction) and the first direction (X-axis direction) may be restricted, and the support frame 240 may move only in the second direction (Y-axis direction) relative to the carrier 300. With the above-mentioned motion of the support frame 240 and the lens holder 220, the movement of the lens barrel 100 in the optical axis direction (Z-axis direction) may be restricted, and the lens barrel 100 may move only in the second direction (Y-axis direction) and the first direction (X-axis direction) relative to the carrier 300.

The lens barrel 100 and the lens driving device 12 may be accommodated in an internal space of the housing 400. For example, the housing 400 has a box shape opened at upper and lower sides thereof. An image module is disposed under the housing 400.

The image module is a device that converts light, which enters through the lens barrel 100, into an electrical signal and transmits the electrical signal. The image module may include an image sensor 710 and a substrate part.

The image sensor 710 converts light, which enters through the lens barrel 100, into an electrical signal. The image sensor 710 may be disposed under the lens barrel 100 in the optical axis direction (Z-axis direction). The image sensor 710 may be mounted on the first circuit board 730. The image sensor 710 may be electrically connected to the first circuit board 730. For example, the image sensor 710 may be, but is not limited to, any one of a charge coupled device (CCD), a metal oxide semiconductor (MOS), a complementary metal oxide semiconductor (CMOS), CMOS photon detector (CPD), and a charge injection device (CID). The electrical signal converted by the image sensor 710 is outputted as an image through a display unit of the electronic device. The image sensor 710 may be disposed under the lens barrel 100 in the optical axis direction (Z-axis direction).

The substrate part may transmit electrical signals, which are generated from the image sensor 710, to the electronic device such as a camera phone. The substrate part may include the first circuit board 730, a connection substrate 750, and a connector 770.

The electrical signal generated by the image sensor 710 may be transmitted to the first circuit board 730. The first circuit board 730 may include a circuit board, such as a rigid printed circuit board, a flexible printed circuit board, or a rigid flexible printed circuit board, having wiring patterns capable of being electrically connected.

The connector 770 may be electrically connected to the first circuit board 730. The connector 770 may include a port 773 that may be electrically connected to an external device. The connection substrate 750 may electrically connect the first circuit board 730 and the connector 770. The connection substrate 750 may include a flexible printed circuit board. The first circuit board 730 may be electrically connected to a lens driving part.

Although not illustrated, an optical filter may be positioned between the lens barrel 100 and the image sensor 710. The optical filter may prevent light beams, which have a particular frequency band among the light beams passing through the lens, from entering the image sensor 710. The optical filter may be disposed to be parallel to a direction perpendicular to the optical axis direction (Z-axis direction). The optical filter may include an infrared blocking filter.

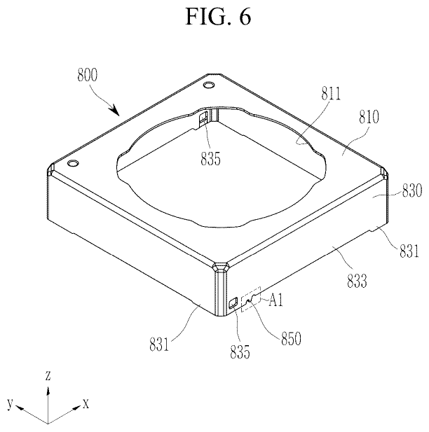

FIG. 6 is a perspective view illustrating the cover 800 illustrated in FIG. 2.

With reference to FIGS. 1 and 6, the cover 800 may be coupled to the housing 400 and surround an outer surface of the housing 400. The cover 800 may have a frame shape with four edges opened at a lower side thereof. The cover 800 protects internal configuration components in the camera module 10. In addition, the cover 800 may serve to block electromagnetic waves. For example, the cover 800 may block electromagnetic waves so that the electromagnetic waves generated in the camera module 10 do not affect the other electronic components in an electronic device. The cover 800 may be coupled to the first circuit board 730 and grounded. The cover 800 may have a center opening. The center opening of the lens holder 220, the center opening of the housing 400, and the center opening of the cover 800 may be aligned in the optical axis direction (Z-axis direction).

For example, the cover 800 may be formed as a board made of a metallic material. The cover 800 may be made of a material, such as stainless, having a low corrosion rate. The cover 800 includes a cover upper surface portion 810 disposed at an upper side based on the optical axis direction (Z-axis direction) and disposed in a planar direction, and a cover side surface portion 830 extending in the optical axis direction (Z-axis direction) from the cover upper surface portion 810.

The cover upper surface portion 810 may have a quadrangular shape and have a cover opening 811 formed at a center thereof. A middle portion of the lens barrel 100 may be exposed through the cover opening 811, and the lens may also be exposed, such that light may pass through the lens.

The cover side surface portion 830 may extend downward in the optical axis direction (Z-axis direction) from an edge of the cover upper surface portion 810. For example, the cover side surface portion 830 may have four surfaces, and the adjacent surfaces may be perpendicular to each other. That is, the cover side surface portion 830 may have a quadrangular column shape opened at upper and lower sides thereof. However, the shape of the cover side surface portion 830 is not limited thereto. For example, the cover side surface portion 830 may have a cylindrical or hemispherical shape opened at a lower side thereof.

The cover side surface portion 830 may include seating portions 831, spacing portions 833, and connection portions 850.

The seating portion 831 is a portion that is in contact with the first circuit board 730. The seating portion 831 may extend downward in the optical axis direction (Z-axis direction) from the cover upper surface portion 810 and be in direct contact with the first circuit board 730.

The spacing portion 833 is a portion that extends downward in the optical axis direction (Z-axis direction) from the cover upper surface portion 810 and is not in direct contact with the first circuit board 730. Therefore, the seating portion 831 may have a longer length, which is measured in the optical axis direction (Z-axis direction), than the spacing portion 833. For example, the seating portions 831 may be positioned at two opposite ends of the spacing portion 833.

The cover 800 and the housing 400 may be coupled to each other. For example, the cover side surface portion 830 may have fastening grooves 835. A fixing protrusion (not illustrated) of the housing 400 may be inserted into the fastening groove 835. The fixing protrusion of the housing 400 is inserted into the fastening groove 835, such that the cover 800 may be fixedly coupled to the housing 400.

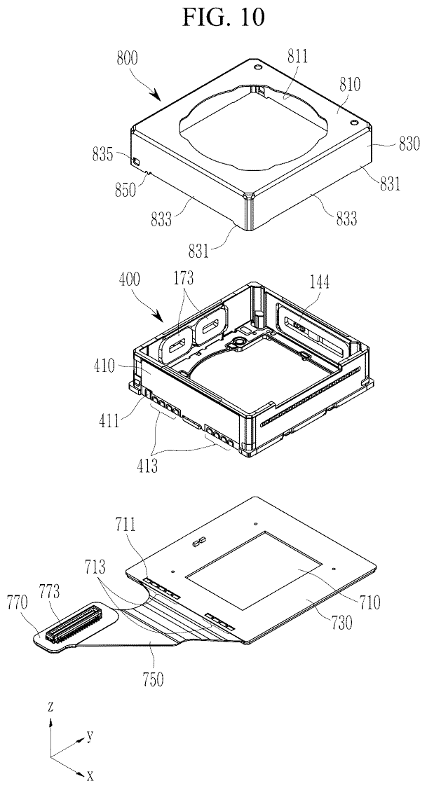

The connection portion 850 is a portion that is not in direct contact with the first circuit board 730. The connection portion 850 is a portion to which first solder 861 is coupled. The connection portion 850 may have at least one concave portion. In addition, the connection portion 850 may further include a convex portion. The first solder 861 may be in contact with the connection portion 850 and the first circuit board 730 to connect the first solder 861 and the first circuit board 730. The cover 800 and the first circuit board 730 may be electrically connected by the first solder 861. The first solder 861 may be connected to a ground pad 711 (FIG. 10) of the first circuit board 730. The connection portion 850 may be connected to the first circuit board 730 by the first solder 861 to provide a ground.

The first solder 861 may be in contact with the connection portion 850, the first circuit board 730, and the second circuit board 410 to connect them to each other. That is, the first solder 861 may be connected to the connection portion 850, the ground pad 711 of the first circuit board 730, and a dummy pad 411 of the second circuit board 410. The cover 800, the first circuit board 730, and the second circuit board 410 may be physically and electrically connected by the first solder 861.

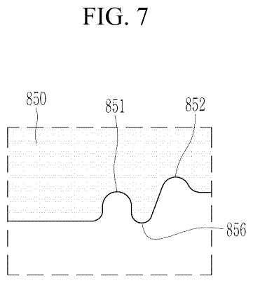

FIGS. 7, 8, and 9 are views illustrating various shapes of the connection portion 850 illustrated in A1 in FIG. 6.

With reference to FIGS. 1, 7, 8, and 9, the connection portion 850 may have a first concave portion 851. The first solder 861 may be disposed to entirely cover the first concave portion 851. By entirely covering the first concave portion 851, the concentration of stress at an interface between the cover 800 and the soldering may be dispersed. The stress may be caused by thermal deformation. Because the first solder 861 entirely covers the first concave portion 851, the likelihood of the occurrence of cracks between the cover and the soldering may be reduced, resulting in preventing a failure of ground.

With reference to FIG. 7, the connection portion 850 may further have a first convex portion 856. The first solder 861 may entirely cover the entire first concave portion 851 and also cover at least a part of the first convex portion 856. In this case, the stress may be dispersed more widely in comparison with a case in which the first solder 861 covers only the first concave portion 851. Therefore, it is possible to further reduce the likelihood of the occurrence of cracks between the cover and the soldering.

The connection portion 850 may further have a second concave portion 852. In this case, the first convex portion 856 may be positioned between the first concave portion 851 and the second concave portion 852. The second concave portion 852 may be a component required to easily form the first convex portion 856 at the time of manufacturing the cover 800. In other words, the first concave portion 851 and the second concave portion 852 each have a shape concave upward in the optical axis direction (Z-axis direction). In this case, a highest point of the first concave portion 851 and a highest point of the second concave portion 852 may be different from each other. For example, the highest point of the second concave portion 852 may be positioned above the highest point of the first concave portion 851 in the optical axis direction (Z-axis direction). However, the present disclosure is not limited thereto.

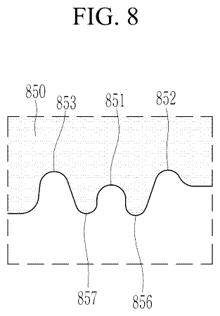

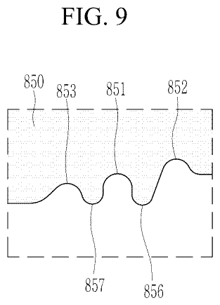

With reference to FIGS. 8 and 9, the connection portion 850 may further have the first convex portion 856 and a second convex portion 857. The first concave portion 851, the first convex portion 856, and the second convex portion 857 may be disposed in the first direction (X-axis direction). In this case, the first concave portion 851 may be positioned between the first convex portion 856 and the second convex portion 857. The first solder 861 may entirely cover the first concave portion 851, at least a part of the first convex portion 856, and at least a part of the second convex portion 857. In this case, it is possible to further disperse the concentration of stress in comparison with a case in which the first solder 861 covers a part of the first convex portion 856 and the first concave portion 851. Therefore, it is possible to further reduce the likelihood of the occurrence of cracks between the cover and the soldering.

The connection portion 850 may further have the second concave portion 852 and a third concave portion 853. The second concave portion 852 and the third concave portion 853 may be disposed in the first direction (X-axis direction). In this case, the first convex portion 856 may be positioned between the first concave portion 851 and the second concave portion 852, and the second convex portion 857 may be positioned between the first concave portion 851 and the third concave portion 853. The third concave portion 853 may be a component required to easily form the second convex portion 857 at the time of manufacturing the cover 800. The highest point of the first concave portion 851, the highest point of the second concave portion 852, and the highest point of the third concave portion 853 may be different from one another. For example, the highest point of the second concave portion 852 may be higher than the highest point of the first concave portion 851 and positioned at the same height as the highest point of the third concave portion 853 (see FIG. 8). As another example, the highest point of the first concave portion 851 may be positioned between the highest point of the second concave portion 852 and the highest point of the third concave portion 853 (see FIG. 9). In the optical axis direction (Z-axis direction), the highest point of the first concave portion 851, the highest point of the second concave portion 852, and the highest point of the third concave portion 853 may be different from one another. However, the positional relationship between the highest points is provided for illustrative purposes only, and the present embodiment is not limited thereto.

In addition, FIGS. 7 to 9 illustrate the examples of the shape of the connection portion 850. However, the shape of the connection portion 850 is not limited thereto, and the connection portion 850 may have various shapes.

FIG. 10 is a perspective view illustrating a state in which the cover, the housing, and the image module, which are illustrated as being coupled in FIG. 1, are disassembled.

With reference to FIGS. 1 and 10, the cover 800, the second circuit board 410, and the first circuit board 730 may be coupled to one another. The cover 800, the second circuit board 410, and the first circuit board 730 may be coupled by the first solder 861.

The second circuit board 410 may have the dummy pad 411 and a signal pad 413. The dummy pad 411 and the signal pad 413 may be positioned in a direction opposite to a direction in which the second circuit board 410 faces the housing 400. The first circuit board 730 may have a ground pad 711 and a signal pad 713. The ground pad 711 and the signal pad 713 may be positioned in a direction opposite to a direction in which the first circuit board 730 faces the housing 400.

The connection portion 850 may cover a part of the dummy pad 411. The entirety of the first concave portion 851 may cover a part of the dummy pad 411. The first solder 861 may be formed to overlap the dummy pad 411. The first solder 861 may be formed on the dummy pad 411 to entirely cover the first concave portion 851. The connection portion 850, the second circuit board 410, and the first circuit board 730 may be connected to one another by the first solder 861 formed on the dummy pad 411. The ground pad 711 of the first circuit board 730 and the dummy pad 411 of the second circuit board 410 may be connected by the first solder 861. The first solder 861 is formed on the dummy pad 411, such that the cover 800, the housing 400, and the first circuit board 730 may be coupled to one another by means of the second circuit board 410. The dummy pad 411 may be insulated from another circuit of the second circuit board 410.

Second solder 863 may be formed to overlap the signal pad 413 of the second circuit board 410. The second circuit board 410 and the first circuit board 730 may be connected to each other by the second solder 863 formed on the signal pad 413. The signal pad 713 of the first circuit board 730 and the signal pad 413 of the second circuit board 410 may be connected by the second solder 863. The second circuit board 410 and the first circuit board 730 may be physically and electrically connected by the second solder 863. The second solder 863 is formed on the signal pad 413, such that the housing 400 and the first circuit board 730 may be coupled to each other by means of the second circuit board 410. The second solder 863 may be spaced apart from the cover 800.

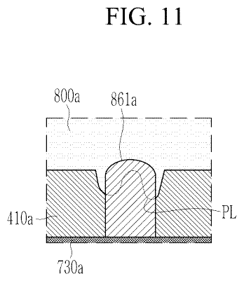

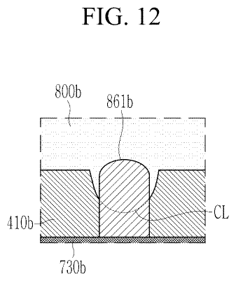

FIG. 11 is a side view illustrating a state in which the cover 800a, the first circuit board 730a, and the second circuit board 410a are soldered according to the present embodiment, and FIG. 12 is a side view illustrating a state in which a cover 800b, a first circuit board 730b, and a second circuit board 410b are soldered according to a comparative example.

With reference to FIGS. 11 and 12, in the case of the present embodiment, first solder 861a is formed to entirely cover a concave shape formed in a cover 800a. In the case of the comparative example that is the related art, first solder 861b, which has the same size as the first solder 861a of the present embodiment, covers a convex shape formed in the cover 800b. In the interface between the cover and the first solder, it can be ascertained that a length PL of the interface according to the present embodiment is significantly longer than a length CL of the interface according to the comparative example.

The interface between the cover and the first solder may crack because of a change in thermal environment that surrounds the camera module. The likelihood of the occurrence of cracks is reduced as an area of the interface between the cover and the first solder increases. Because the length PL of the interface between the cover 800a and the first solder 861a according to the present embodiment is longer than the length CL of the interface between the cover 800b and the first solder 861b in the related art, the stress applied to the interface may be dispersed more widely. Therefore, according to the present embodiment described above, the likelihood of the occurrence of cracks is reduced, which may prevent a failure of ground.

### Experimental Examples

Camera modules of Examples 1 to 11 were manufactured by forming the shape of the connection portion, as illustrated in FIG. 8. The first solder was formed to cover the first concave portion, a part of the first convex portion, a part of the second convex portion, and the dummy pad and be connected to the ground pad of the first circuit board.

The cover was manufactured to form the convex shape at the position of the first concave portion instead of the first concave portion, and camera modules of Comparative Examples 1 to 13 were manufactured so that the convex shape of the cover overlapped a part of the dummy pad. The first solder was formed to cover the convex shape and the dummy pad and extend to the first circuit board.

Direct current resistance (DCR) of the camera modules according to Comparative Examples 1 to 13 and Examples 1 to 11 in an initial state (initial) was measured. After tests for changing the thermal environment from a low temperature to a high temperature were performed by 100 cycles and 200 cycles, and the direct current resistance was measured. The results are shown in Table 1.

TABLE 1

| | Initial | 100 cycle | 200 cycle | 200 cycle/Initial |
|---|---|---|---|---|
| Comparative | 0.161 | 0.162 | 0.205 | 127.3% |
| Example 1 | | | | |
| Comparative | 0.162 | 0.116 | 0.228 | 140.7% |
| Example 2 | | | | |
| Comparative | 0.135 | 0.171 | open | — |
| Example 3 | | | | |
| Comparative | 0.282 | 0.233 | 0.289 | 102.5% |
| Example 4 | | | | |
| Comparative | 0.138 | 0.111 | 0.186 | 134.8% |
| Example 5 | | | | |
| Comparative | 0.145 | 0.138 | 19.063 | 13146.9% |
| Example 6 | | | | |
| Comparative | 0.192 | 0.128 | 0.157 | 81.8% |
| Example 7 | | | | |
| Comparative | 0.153 | 0.142 | open | — |
| Example 8 | | | | |
| Comparative | 0.157 | 0.128 | 0.151 | 96.2% |
| Example 9 | | | | |
| Comparative | 0.146 | 0.245 | 0.129 | 88.4% |
| Example 10 | | | | |
| Comparative | 0.224 | 0.123 | open | — |
| Example 11 | | | | |
| Comparative | 0.218 | 0.119 | 0.175 | 80.3% |
| Example 12 | | | | |
| Comparative | 0.149 | 0.156 | 0.194 | 130.2% |
| Example 13 | | | | |
| Example 1 | 0.107 | 0.114 | 0.099 | 106.5% |
| Example 2 | 0.104 | 0.142 | 0.102 | 136.5% |
| Example 3 | 0.099 | 0.107 | 0.091 | 108.1% |
| Example 4 | 0.098 | 0.095 | 0.096 | 96.9% |
| Example 5 | 0.098 | 0.098 | 0.097 | 100.0% |
| Example 6 | 0.104 | 0.113 | 0.096 | 108.7% |
| Example 7 | 0.099 | 0.092 | 0.091 | 92.9% |
| Example 8 | 0.093 | 0.118 | 0.094 | 126.9% |
| Example 9 | 0.091 | 0.104 | 0.097 | 114.3% |
| Example 10 | 0.099 | 0.099 | 0.11 | 100.0% |
| Example 11 | 0.091 | 0.091 | 0.1 | 100.0% |

As shown in Table 1, in Examples 1 to 11, the direct current resistance after 200 cycles was at a level approximately similar to the level of the direct current resistance in the initial state. In contrast, in Comparative Examples 1 to 13, the direct current resistance after 200 cycles was sometimes not measured (Comparative Examples 3, 8, and 11). This was because the solder cracks, and the cover and the first circuit board were disconnected. In addition, the direct current resistance was sometimes significantly increased (Comparative Example 6). This is because the solder greatly cracks even though the cover and the first circuit board are not disconnected.

Therefore, according to the present embodiment, it can be ascertained that it is possible to reduce the likelihood of the occurrence of cracks in the solder and prevent a failure of ground by reducing an area of the concentration of stress that may occur on the interface between the solder and the cover in accordance with the thermal environment.

According to one or more embodiments as described herein, it is possible to disperse the concentration of stress applied to the interface between the cover and the soldering. Therefore, the likelihood of the occurrence of cracks between the cover and the soldering may be reduced, which may prevent a failure of ground.

However, the effects of the one or more embodiments as described herein are not limited to the above-described effects, and it is apparent that they can be variously expanded without departing from the spirit and scope of the present disclosure.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing that accommodates a lens barrel; and
a cover that covers the housing,
wherein the cover comprises a connection portion connected to a first circuit board by a first solder to provide a ground to the first circuit board, and
wherein the connection portion comprises a first concave portion having a concave shape in a first direction from the first circuit board toward the housing.

2. The camera module of claim 1, wherein the connection portion is connected to a ground pad of the first circuit board by the first solder to provide the ground to the first circuit board.

3. The camera module of claim 1, wherein the first concave portion of the connection portion is entirely covered by the first solder.

4. The camera module of claim 1, wherein:
the connection portion further comprises a first convex portion and a second convex portion each having a convex shape in a direction from the housing toward the first circuit board, and
the first concave portion is disposed between the first convex portion and the second convex portion.

5. The camera module of claim 4, wherein:
the connection portion further comprises a second concave portion and a third concave portion each having a concave shape in the first direction,
the first convex portion is disposed between the first concave portion and the second concave portion, and
the second convex portion is disposed between the first concave portion and the third concave portion.

6. The camera module of claim 1, wherein an image sensor is mounted on the first circuit board.

7. The camera module of claim 1, wherein:
the connection portion is connected to a dummy pad of a second circuit board by the first solder, and
an optical image stabilization (OIS) driving coil is mounted on the second circuit board.

8. The camera module of claim 7, wherein a signal pad of the first circuit board and a signal pad of the second circuit board are connected by a second solder.

9. The camera module of claim 8, wherein the second solder is spaced apart from the cover.

10. A camera module comprising:
a lens barrel that accommodates a lens;
a housing that accommodates the lens barrel;
a first circuit board on which the housing is seated; and
a cover that covers the housing,
wherein the cover comprises a connection portion connected to a ground pad of the first circuit board by first solder, and
wherein the connection portion comprises a first concave portion having a concave shape in a first direction from the first circuit board toward the housing, and a convex portion having a convex shape in a direction from the housing toward the first circuit board.

11. The camera module of claim 10, wherein the first concave portion of the connection portion is entirely covered by the first solder.

12. The camera module of claim 10, wherein:
the connection portion further comprises a second concave portion having a concave shape in the first direction, and
the convex portion is disposed between the first concave portion and the second concave portion.

13. The camera module of claim 10, further comprising:
a second circuit board connected to the housing in a second direction intersecting the first direction,
wherein the connection portion is connected to a dummy pad of the second circuit board by the first solder.

14. The camera module of claim 13, wherein the first concave portion overlaps the dummy pad of the second circuit board.
